(19) United States
(12) Patent Application Publication
(10) Pub. No.: US 2010/0225624 A1
(43) Pub. Date: Sep. 9, 2010

(54) FLAT DISPLAY PANEL

(76) Inventors: Chien-Hao Fu, Hsin-Chu (TW); Min-Feng Chiang, Hsin-Chu (TW); Ming-Chin Lee, Hsin-Chu (TW); Chun-Huan Chang, Hsin-Chu (TW); Pai-Hung Hsu, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/606,196

(22) Filed: Oct. 27, 2009

(30) Foreign Application Priority Data
Mar. 4, 2009 (TW) 098106944

(51) Int. Cl. G09G 5/00

(52) U.S. Cl. 345/205

(57) ABSTRACT

A flat display panel includes a substrate, at least a driving chip, a plurality of control lines and conductive lines. The substrate has a display area and peripheral circuit area defined thereon. The driving chip is disposed in the peripheral circuit area, and has a plurality of pins. The pitches of adjacent pins are varied. The pitches of the pins in the central portion of the driving chip are smaller than the pitches of the pins in the border portion. The control lines and the conductive lines are disposed in the display area and the peripheral circuit area respectively, and the control lines are electrically connected to the conductive lines.

### BACKGROUND OF THE INVENTION

1. Field of the Invention

The present invention relates to a flat display panel, and more particularly, to a flat display panel having a driving chip including pins with nonequivalent pitches.

2. Description of the Prior Art

In comparison with traditionally non-planar displays such as cathode ray tube (CRT) display, flat displays possess advantages of low weight and thin thickness. In view of this, the flat display has gradually become a trendy product, for instance, in domestic televisions, personal computer displays, and portable electronic products e.g. mobile phones, digital cameras and portable music player devices. According to different display techniques, various types of flat displays may be, plasma display panels (PDPs), liquid crystal displays (LCDs) and organic light emitting diode (OLED) displays. In general, the aforementioned flat displays have electronic devices or illumination devices installed on the thin type substrate. Taking a thin film transistor liquid crystal display (TFT LCD) as an example, the TFT LCD usually includes a top glass substrate and a bottom glass substrate, wherein the thin film transistors, the scan lines, the signal lines and the pixel electrodes are disposed on the surface of the bottom glass substrate, and a color filter and a black matrix layer are disposed on the top glass substrate. The positions of the top glass substrate and the bottom glass substrate bonded together by seal glue are fixed. When liquid crystal molecules are filled between the top glass substrate and the bottom glass substrate, a TFT-LCD panel is accordingly formed. In addition, the TFT-LCD panel usually includes a plurality of chips. As a result, the chips utilize an electrical connection with the scan lines and the signal lines respectively to control the switches of each of the pixels of the display.

Since the flat display panels have gradually become trendy products with high-resolution design, the scan lines and signal lines are in a compact arrangement. Consequently, the pitches of the pins of chips have gradually become smaller, such that lots of technical problems are caused due to the scaled-down manufacturing process. For instance, if the pitches of the pins of the chip are too small, outward expansion resulted from heat of the conductive material leads to a short circuit problem of the pins in the bonding process of chips and conductive lines. In addition, due to the wiring design for the arrangement of the signal lines and the scan lines, the conductive lines electrically connected to one chip usually have different lengths, such that the impedance of each of the conductive lines is nonequivalent. Furthermore, the conduction speed and the quality of the signal lines and scan lines may be influenced.

### SUMMARY OF THE INVENTION

One object of the present invention is to provide a flat display panel. The flat display panel includes at least one driving chip disposed on the substrate, and the pitches of the pins of the driving chip are incompletely identical so as to improve short circuit problem of the pins due to the small pitches of the pins and nonequivalent impedance problem of the conductive lines in the conventional techniques.

The present invention provides a flat display panel. The flat display panel includes a substrate, at least one driving chip, a plurality of control lines and a plurality of conductive lines. The substrate has a display area and a peripheral circuit area defined thereon, and the peripheral circuit area is disposed on at least one side of the display area. The driving chip is disposed in the peripheral circuit area and includes a plurality of pins, and the pitches of the adjacent pins are incompletely identical. In addition, the control lines are disposed in the display area, and the conductive lines are disposed in the peripheral circuit area and electrically connected to the control lines and to the pins. The aforementioned conductive lines include at least a first conductive line, a second conductive line adjacent to the first conductive line and a third line adjacent to the first conductive line. A first pitch is between the pin electrically connected to the first conductive line and the pin electrically connected to the second conductive line, and a second pitch is between the pin electrically connected to the first conductive line and the pin electrically connected to the third conductive line. The first pitch is larger than the second pitch, the width of the second conductive line is larger than the width of the first conductive line, and the width of the first conductive line is larger than the width of the third conductive line.

According to the invention, a flat display panel is further disclosed. The flat display panel includes a substrate, at least one driving chip, a plurality of control lines and a plurality of conductive lines. The substrate has a display area and a peripheral circuit area defined thereon, and the peripheral circuit area is disposed on at least one side of the display area. The driving chip is disposed in the peripheral circuit area and includes a plurality of pins. The pitches of the adjacent pins are incompletely identical, and the pitches of the pins in the central portion of the driving chip are smaller than those of the pins in the border portion of the driving chip. The control lines are disposed in the display area, the conductive lines are disposed in the peripheral circuit area and electrically connected to the control lines and the pins, and at least parts of the conductive lines have winding regions.

Since the driving chip of the flat display panel of the present invention has the pins and the pitches of the pins are nonequivalent, the short circuit problem may be efficiently avoided due to the too small pitches in the prior art. Meanwhile, the conductive lines in the border portion electrically connected to the pins having larger pitches therebetween may have larger widths so as to lower the impedance of the conductive lines. Consequently, the larger amount of winding lines or the wiring design is not needed for use in configuring the conductive lines disposed in the central portions. As a result, the impedance of the conductive lines may be equalized, and the material cost and wiring space may be saved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a top view of a flat display panel.

FIG. 2 is an enlarged schematic diagram illustrating parts of devices of FIG. 1.

FIG. 3 is a schematic diagram illustrating a second embodiment of the driving chip and the conductive line design of the flat display panel of the present invention.

FIG. 4 is a schematic diagram illustrating a third embodiment of the driving chip and the wiring design of the flat display panel of the present invention.

FIG. 5 is an enlarged schematic diagram illustrating parts of the conductive lines 26n.

FIG. 6 is a schematic diagram illustrating a fourth embodiment of the driving chip and the wiring design of the flat display panel of the present invention.

FIG. 7 is a schematic diagram illustrating a fifth embodiment of the driving chip and the wiring design of the flat display panel of the present invention.

### DETAILED DESCRIPTION

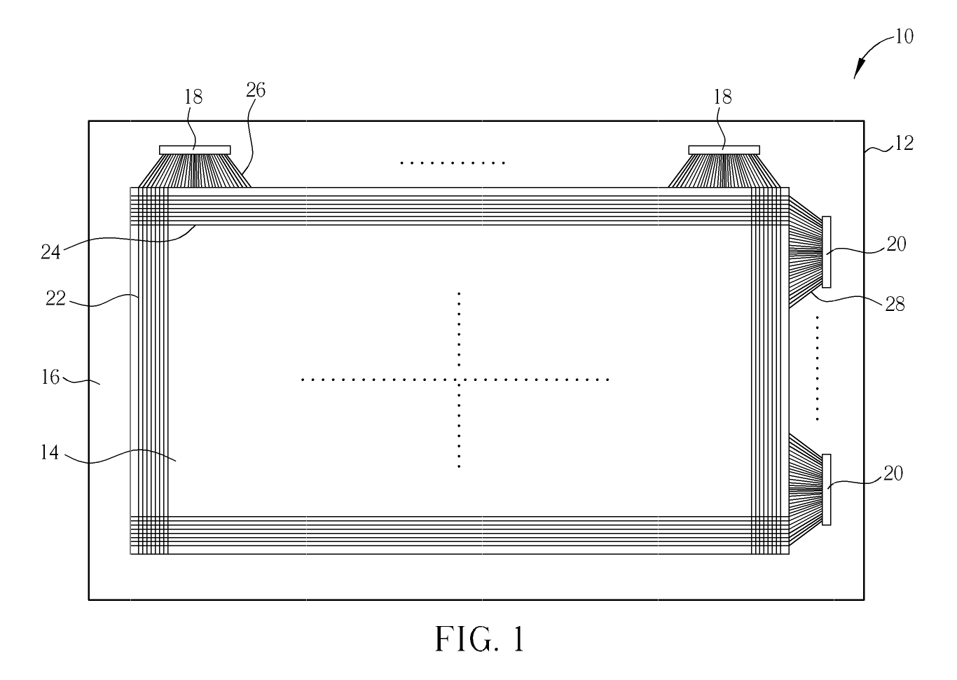

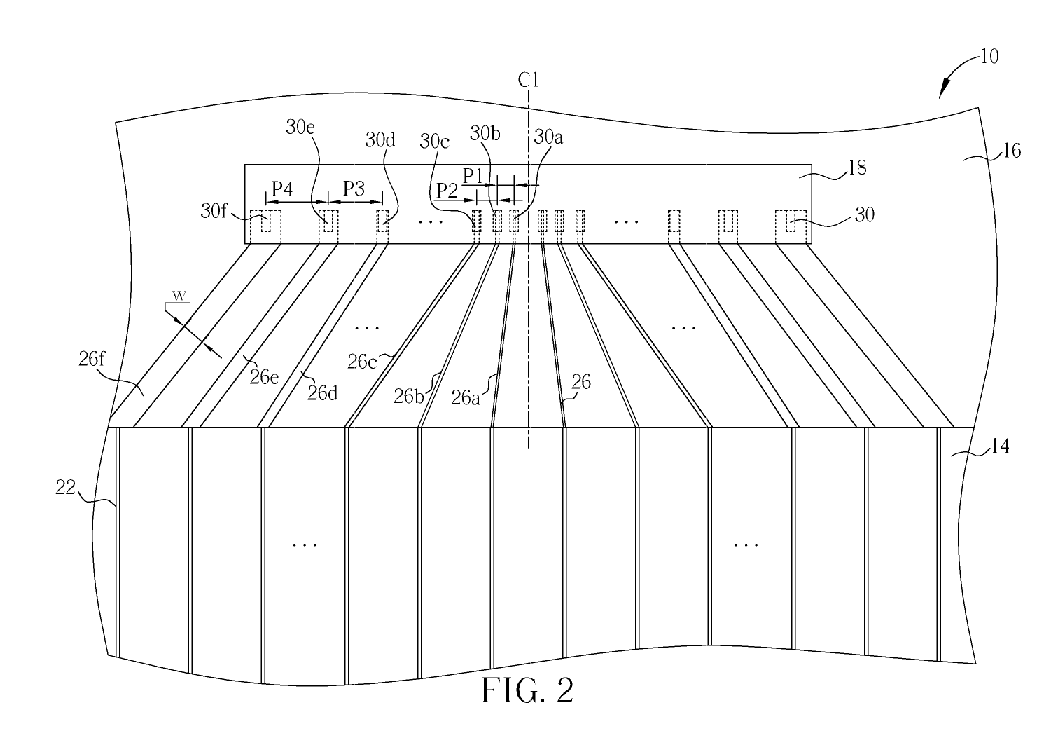

With reference to FIG. 1 and FIG. 2, FIG. 1 and FIG. 2 are schematic diagrams illustrating a first embodiment of a flat display panel of the present invention, wherein FIG. 1 is a schematic diagram illustrating a top view of the flat display panel, and FIG. 2 is an enlarged schematic diagram illustrating parts of devices of FIG. 1. As illustrated in FIG. 1, the flat display panel 10 of the present invention includes a substrate 12. A display area 14 and a peripheral circuit area 16 are defined on the substrate 12, wherein the peripheral circuit area 16 is disposed on at least a side of the display area 14. In this embodiment, the peripheral circuit area 16 surrounds the display area 14. The flat display panel 10 further includes a plurality of driving chips 18, 20 disposed in the peripheral circuit area 16, a plurality of control lines 22, 24 disposed in the display area 14, and a plurality of conductive lines 26, 28 disposed in the peripheral circuit area 16. The conductive lines 26 and the conductive lines 28 are electrically connected to control lines 22 and control lines 24 respectively. The control lines 22 and the control lines 24 may be signal lines and scan lines respectively, and each of the driving chips 18 and each of the driving chips 20 may include a signal line driving circuit and a scan line driving circuit respectively. In the display region 14, the pluralities of signal lines are parallel to each other, and the pluralities of scan lines are parallel to each other. In addition, the driving chips 18, 20 preferably include chip-on-film (COF) packaged chips, which may be directly attached on the surface of flexible soft films (not shown), and the flexible soft films are attached on the peripheral circuit area 16.

With reference to FIG. 2, FIG. 2 is an enlarged schematic diagram illustrating one of the driving chips 18 and the conductive lines 26 of FIG. 1. The driving chip 18 includes a plurality of pins 30 arranged in parallel, and the pitches of the adjacent pins 30 are incompletely identical. For instance, the pitch between the pin 30a and the pin 30b is defined as pitch P1; the pitch between the pin 30b and the pin 30c is defined as pitch P2; the pitch between the pin 30d and the pin 30e is defined as pitch P3; and the pitch between the pin 30e and the pin 30f is defined as pitch P4, wherein the pitch P1, the pitch P2, the pitch P3 and the pitch P4 are incompletely identical. In this embodiment, the pitches of the pins 30 adjacent to the peripheral or the border portion of the driving chip 18 are larger than those of the pins 30 far from the peripheral or the border portion of the driving chip 18. As illustrated in FIG. 2, a central line C1 is defined on the driving chip 18 and therefore the driving chip 18 is divided into a left side and a right side. The pins 30a, 30b, 30c, 30d, 30e and 30f are disposed on the left side of the central line C1 from the central line C1 to the border portion of the driving chip 18 in sequence. Consequently, the pitch P1 is smaller than the pitch P2, the pitch P2 is smaller than the pitch P3, and the pitch P3 is smaller than the pitch P4. Meanwhile, the pitch of any pins 30 between the pin 30c and the pin 30d is larger than the pitch P2 and smaller than the pitch P3. In the preferable embodiment, the smallest pitch of adjacent pins 30 such as pitch P1 is about 20 micrometers, and the largest pitch such as the pitch P4 is about 50 micrometers. In other words, the minimum pitch and the maximum pitch of the adjacent pins 30 of the driving chip 18 are about 20 micrometers and about 50 micrometers respectively. In addition, the pins 30 disposed on the two opposite sides of the central line C1 are symmetrically arranged on the left and right sides with respect to the central line C1 serving as a symmetric line. That is, if the pins 30 on the right side of the central line C1 are more away from the central line C1, the pitches of the pins become larger. Moreover, the number of the conductive lines 26 is corresponding to that of the pins 30 of the driving chip 18, and each of the conductive lines 26 is electrically connected to a pin 30 respectively. In order to explain the arrangement with ease, the conductive lines 26 shown in FIG. 2 are denoted by virtue of the number of symbols 26a-26f. The third conductive line 26a, the first conductive line 26b, the second conductive line 26c, the sixth conductive line 26d, the fourth conductive line 26e and the fifth conductive line 26f are disposed on the left side of the central line C1 in sequence, wherein the third conductive line 26a and the second conductive line 26c are adjacent to the first conductive line 26b, the sixth conductive line 26d and the fifth conductive line 26f are adjacent to the fourth conductive line 26e, and the conductive lines 26 disposed between the second conductive line 26c and the sixth conductive line 26d are omitted and not shown in FIG. 2. The third conductive line 26a, the first conductive line 26b, the second conductive line 26c, the sixth conductive line 26d, the fourth conductive line 26e and the fifth conductive line 26f are electrically connected to the pins 30a, 30b, 30c, 30d, 30e and 30f respectively. Consequently, the pitch P1 of the pin 30b electrically connected to the first conductive line 26b and the pin 30a electrically connected to the third conductive line 26a is smaller than the pitch P2 of the pin 30b electrically connected to the first conductive line 26b and the pin 30c electrically connected to the second conductive line 26c. Meanwhile, the sixth conductive line 26d and the fifth conductive line 26f are adjacent to the fourth conductive line 26e and disposed on the two sides of the fourth conductive line 26e, a pitch of the pin 30e electrically connected to the fourth conductive line 26e and the pin 30d electrically connected to the sixth conductive line 26d is defined as the pitch P3, a pitch of the pin 30e electrically connected to the fourth conductive line 26e and the pin 30f electrically connected to the fifth conductive line 26f is defined as the pitch P4, and the pitch P4 is larger than the pitch P3.

It should be noted that since the pitches of adjacent pins 30 are incompletely identical, the pitches of some adjacent pins 30 may be identical. For instance, if the driving chip 18 includes the pitches P1, P2, P5, P6, P3, P4 (P5 and P6 are not shown) disposed from the left side of the central line C1 to the border portion of the driving chip 18 in sequence, the relationship of the aforementioned pitches of the pins 30 may be P1<P2<P5=P6<P3<P4.

On another hand, the widths of the conductive lines 26 may be incompletely identical. In this embodiment, the conductive lines 26 disposed on the two sides of the central line C1 are arranged symmetrically with respect to the central line C1 serving as a symmetric axis, the widths of the conductive lines 26 electrically connected to the pins 30 in the border portion of the driving chip 18 are larger than those of the conductive lines 26 electrically connected to the pins 30 in the central portion of the driving chip 18. Also, the width of the conductive line 26 becomes larger when approaching the border portion of the driving chip 18. For instance, the width of the fifth conductive line 26f is larger than that of the fourth conductive line 26e, and the width of the fourth conductive line 26e is larger than that of the sixth conductive line 26d. Therefore, the widths of all the conductive lines 26 on the same side of the central line C1 of the driving chip 18 are different. In preferred embodiments, the minimum width w of the conductive lines 26 is about 6 micrometers to about 8 micrometers.

Since the conductive lines 26 electrically connected to the single driving chip 18 form a fan-out block disposed in the peripheral circuit area 16, the lengths of the conductive lines 26 adjacent to the border portion of the driving chip 18 e.g. the six conductive line 26d, the fourth conductive line 26e and the fifth conductive line 26f are larger than those of the conductive lines 26 adjacent to the central portion of the driving chip 18 e.g. the third conductive line 26a, the first conductive line 26b and the second conductive line 26c. In order to prevent the conductive lines 26 with longer length in the border portion from having higher impedance, the conductive lines 26 in the border portion have wider widths, such that the impedances of all of the conductive lines 26 may be equalized and uniform. In addition, because the pitches of the pins 30 of the driving chip 18 are different and the pitches of the pins 30 adjacent to the border portion become larger, there are larger distance and space between the adjacent conductive lines 26. Therefore, the widths of the conductive lines 26 may be increased to efficiently improve the nonequivalent impedances due to the longer lengths of the wiring lines.

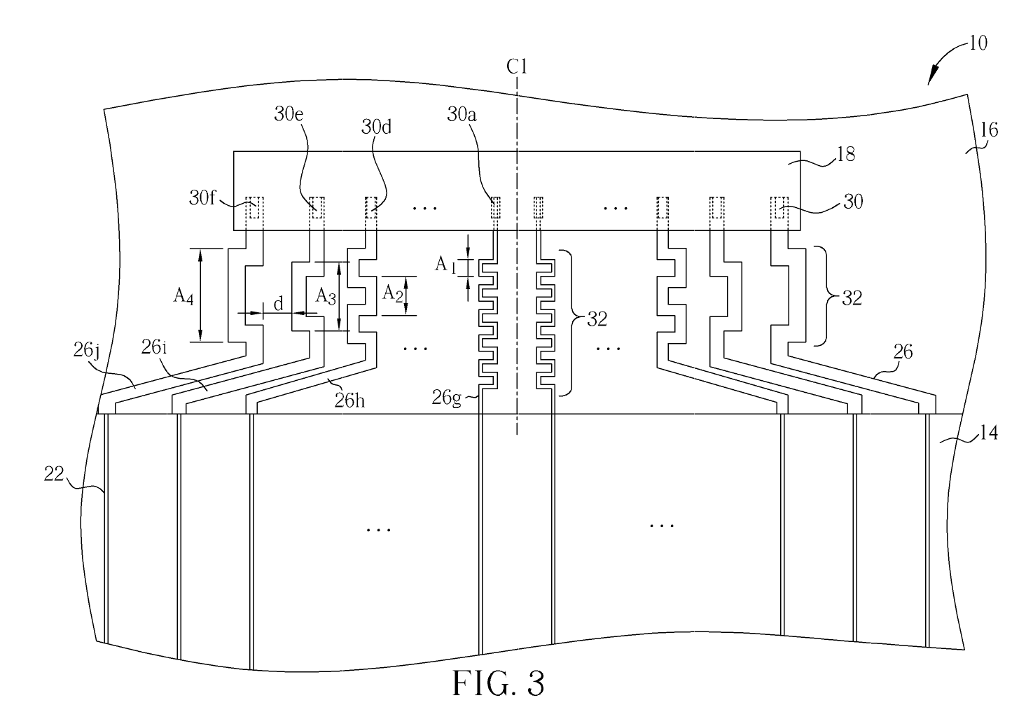

With reference to FIG. 3, FIG. 3 is a schematic diagram illustrating a second embodiment of the driving chip and the conductive line design of the flat display panel of the present invention. In order to explain the embodiment with ease, identical components compared with the aforementioned embodiment are denoted by identical numerals. The conductive lines 26 disposed on the left side of the central line C1 of the driving chip 18 are respectively denoted by virtue of the number of symbols 26g, 26h, 26i and 26j. In the second embodiment, each of the conductive lines 26 has a winding region 32 respectively. In the winding region 32, the conductive line 26 has continuous and repeated serrated shapes or wavelike shapes, wherein the serrated shapes are shown in FIG. 3. The serrated shape or the wavelike shape of each of the conductive lines has a wave amplitude. For instance, the wave amplitudes of the conductive lines 26g, 26h, 26i, 26j are denoted by A₁, A₂, A₃ and A₄ respectively to stand for the width of the trough of each serrated shape. In the preferred embodiment, the wave amplitudes e.g. A₄, A₃ of the conductive lines 26 adjacent to the border portion of the driving chip 18 are larger than the wave amplitudes e.g. A₁ of the conductive lines 26 adjacent to the central portion of the driving chip 18. In other words, the wave amplitude of the conductive line 26 more adjacent to the border portion of the driving chip 18 is slightly larger than the wave amplitude of the conductive line 26 in the inboard portion. In such a design, in the winding regions 32, because the conductive lines 26 having small wave amplitude have larger number of the serrated shapes, their lengths are larger than the lengths of the conductive lines 26 having larger wave amplitudes. Moreover, similar to FIG. 2, the widths of the conductive lines 26 of this embodiment in the border portion are larger than those of the conductive lines 26 adjacent to the central portion of the driving chip 18. For instance, the width of the conductive line 26j is larger than the width of the conductive line 26i, and the width of the conductive line 26h is larger than the width of the conductive line 26g. It should be noted that the minimum distance between the adjacent conductive lines 26 is about 6 micrometers to about 8 micrometers due to the limitation of the lithography and etching process technology at present. For instance, in the winding region 32s, the minimum distance d of each of the serrated shapes of the conductive line 26j and each of the serrated shapes of the conductive line 26i is about 6 micrometers. Moreover, the pins 30 of the driving chip 18 are symmetrically arranged on left and right sides with respect to the central line C1 serving as a symmetric axis. The widths and the wiring patterns of the conductive lines 26 disposed on the two sides of the central line C1 are symmetrically arranged with respect to the central line C1. However, in other embodiments, the pins 30 and the wiring design of the conductive lines 26 on the two sides of the central line C1 are with no need for being completely identical or being symmetrical with each other.

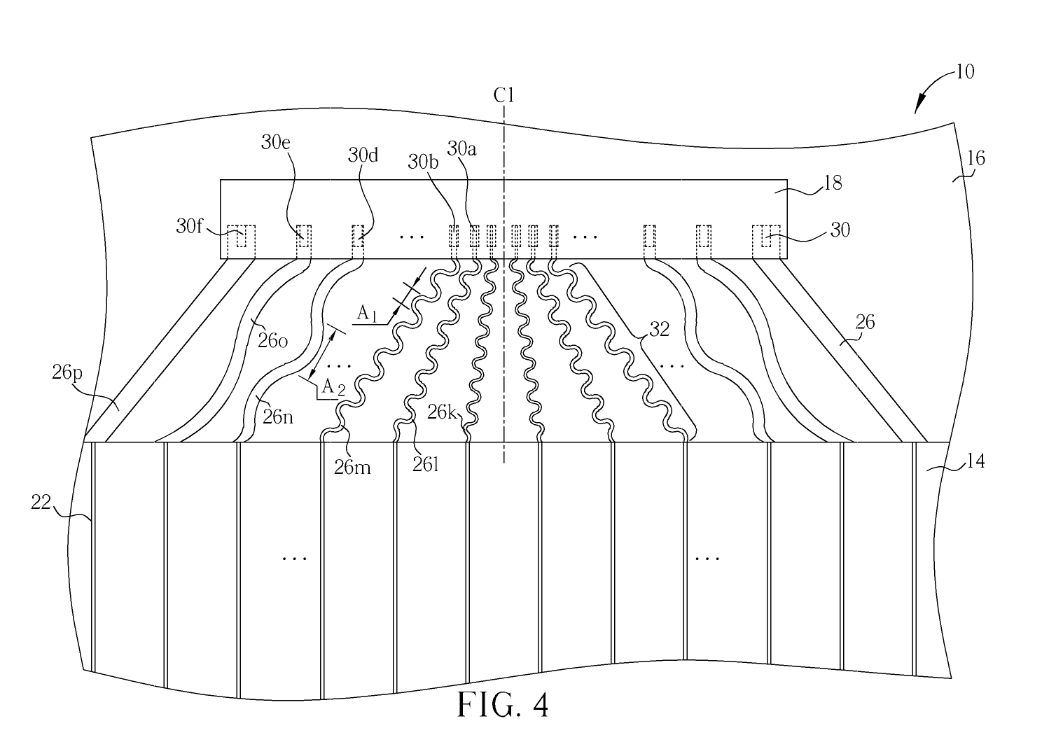

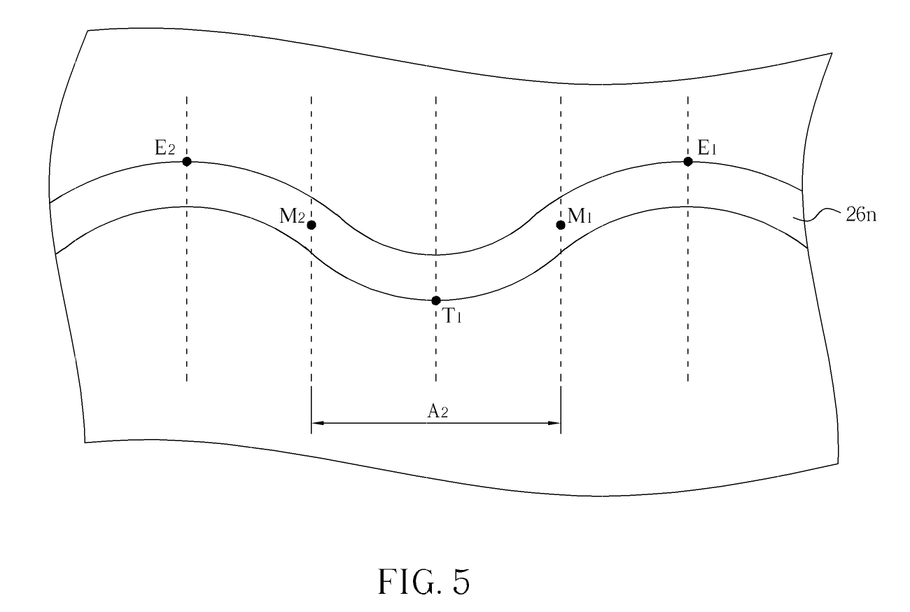

With reference to FIG. 4, FIG. 4 is a schematic diagram illustrating a third embodiment of the driving chip and the wiring design of the flat display panel of the present invention, parts of the components are denoted by identical numerals shown in FIG. 2 and FIG. 3. In this embodiment, parts of the conductive lines 26 have winding regions 32 with wavelike shape pattern disposed in the peripheral circuit area. In the winding regions 32, the wave amplitudes e.g. A₁, A₂ of the conductive lines 26 stand for the lengths of one wavelike shape. Wherein, the wave amplitude is defined as the distance between a midpoint of a wave crest and a wave trough and another adjacent midpoint of a wave crest and a wave trough. In order to clearly explain the definition of wave amplitudes A₁, A₂, FIG. 5 is provided to show an enlarged schematic diagram illustrating parts of the conductive lines 26n. As illustrated in FIG. 5, the wave crest E1 and the wave trough T1 adjacent to each other have a midpoint M1, and the midpoint M2 is positioned between the wave crest E2 and the wave trough T1 adjacent to each other. The distance between the two adjacent midpoints M1, M2 is defined as the wave amplitude A₂ of the conductive line 26n. Referring to FIG. 4, similar to aforementioned embodiment, the wave amplitudes of the conductive liens 26 adjacent to the central line C1, such as the conductive lines 26k, 26l and 26m, are small, whereas the wave amplitudes of the conductive liens 26 adjacent to the border portion, such as the conductive lines 26n and 26o, are large so that their wiring design may be shortened. In addition, the most outside conductive line 26P has no a winding region. However, in other embodiments, some of the conductive lines 26 in the border portion or in the outside e.g. the conductive lines 26n, 26o and 26P may not have any winding regions. Furthermore, similar to the aforementioned embodiment, the widths of the conductive lines 26 more adjacent to the border portion of the driving chip 18 are larger than the widths of the conductive lines 26 far from the border portion of the driving chip 18. For instance, the width of the conductive line 26p is larger than the width of the conductive line 26o, and the width of the conductive line 26m is larger than the width of the conductive line 26l.

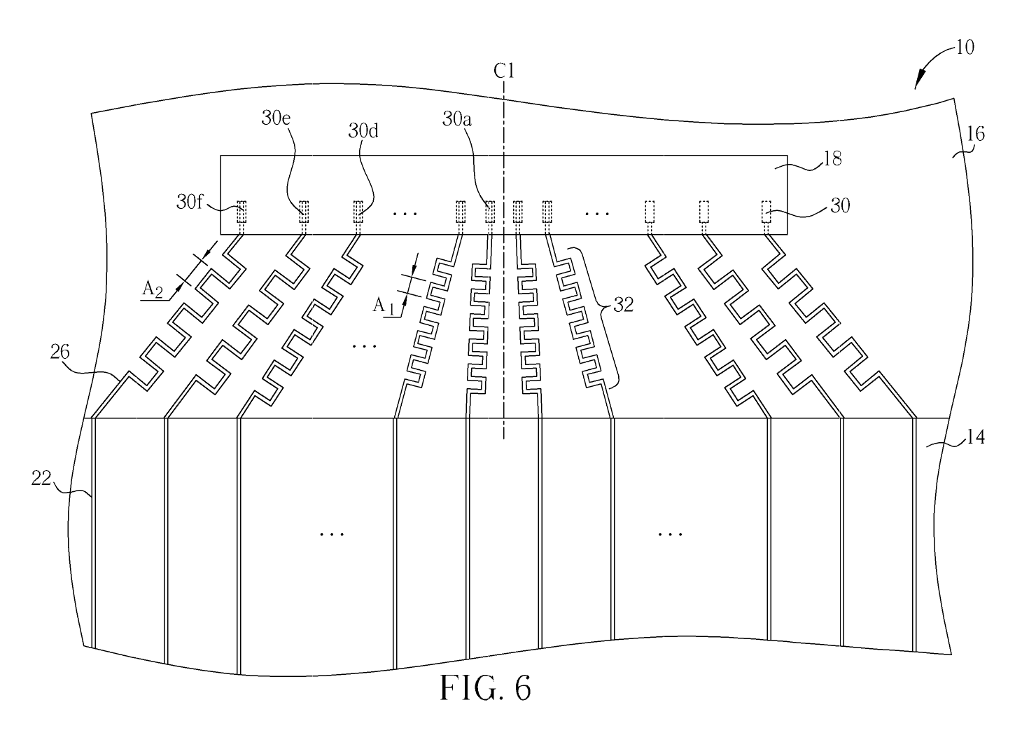

With reference to FIG. 6, FIG. 6 is a schematic diagram illustrating a fourth embodiment of the driving chip and the wiring design of the flat display panel of the present invention. Similar to the aforementioned embodiment, the pitches of the pins 30 of the driving chip 18 are incompletely identical. For instance, the pitches of the pins 30 in the border portion of the driving chip 18 are larger, and the pitches of the pins 30 in the central portion of the driving chip 18 are smaller. In this embodiment, each of the conductive lines 26 is corresponding to a pin 30 and has an identical width. In addition, each of the conductive lines 26 has a winding region 32 including wiring design with a serrated shape pattern. As a result, the wave amplitudes e.g. A₁ of the conductive lines 30 near the central line C1 are smaller, and the conductive lines 26 corresponding to the pins 30 in the border portion or near the edge of the driving chip 18 have larger wave amplitudes.

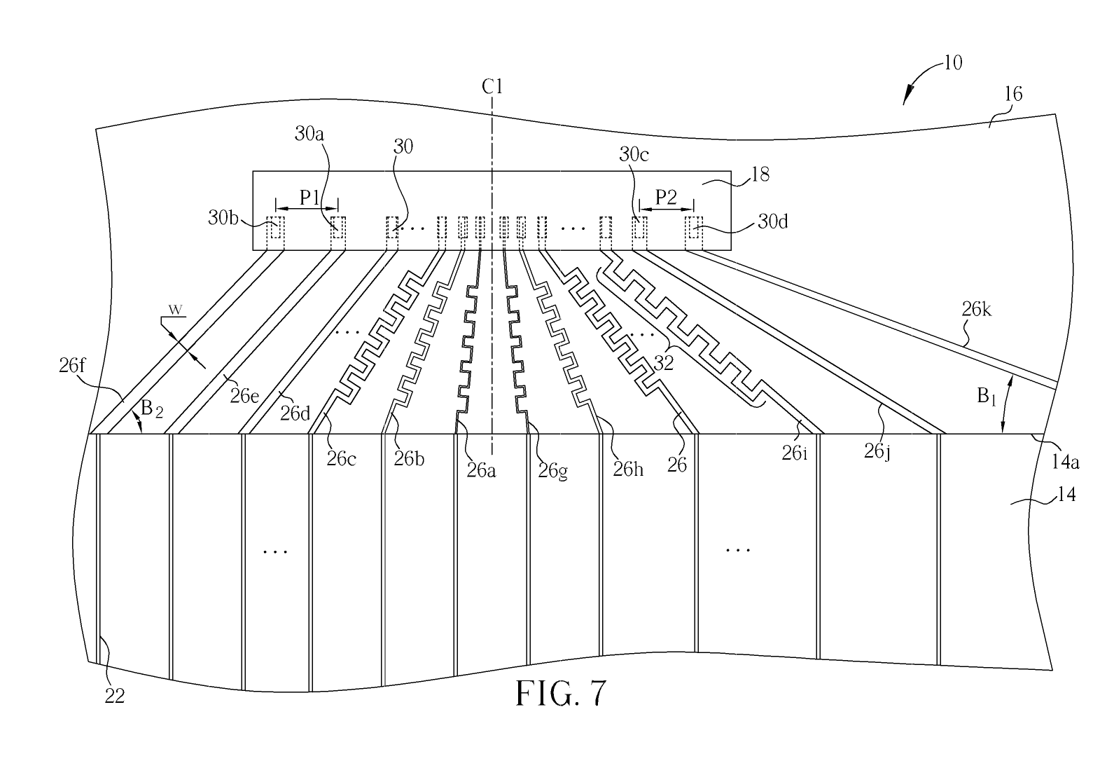

FIG. 7 is a schematic diagram illustrating a fifth embodiment of the driving chip and the wiring design of the flat display panel of the present invention. As illustrated in FIG. 7, the driving chip 18 includes a plurality of pins 30, and the pitches of the pins 30 are incompletely identical. It should be noted that the pins 30 on the left and right sides of the central line C1 are not arranged with mirror symmetry. For instance, the pitch P1 of the two pins 30a, 30b on the very left side of the driving chip 18 is larger than the pitch P2 of the two pins 30c, 30d on the very right side of the driving chip 18. Each of the conductive lines 26 is corresponding to a pin 30 respectively, wherein the widths of the conductive lines 26 near the central portion of the driving chip 18 are smaller than those of the conductive lines 26 adjacent to the border portion of the driving chip 18. For instance, the width of the conductive line 26a is smaller than the width of the conductive line 26c, the width of the conductive line 26d is larger than the width of the conductive line 26c, and the width of the conductive line 26f is larger than the widths of the conductive line 26d and the conductive line 26e. Also, the conductive lines 26 on the right side of the central line C1 have similar wiring design. It should be noted that the conductive lines 26 on the two sides of the central line C1 are not completely symmetrical. For instance, the conductive line 26i on the right side of the central line C1 has a winding region 32, and the conductive lines 26K, 26j do not include a winding region respectively. However, all of the conductive lines 26d, 26e, 26f on the left side of the central line C1 do not include winding regions 32. In addition, the included angle B₁ of the conductive line 26k and the boundary 14a of the display area 14 is not identical to the included angle B₂ of the conductive line 26f and the boundary 14a of the display area 14. In this embodiment, the included angle B₂ is larger than the included angle B₁.

The flat display panel of the present invention may be applied to a PDP, an LCD, an OLED display, or any display panels having conductive lines bonded with chips. Moreover, in the aforementioned embodiment, the wiring design of the signal lines and signal line driving chips is merely an example to explain the spirits of the present invention. Also, similar design may be applied to scan lines, scan line driving chip or other wiring design of conductive lines electrically connected to any pins of chips.

Compared with the conventional technology, since the pins of the driving chip of the flat display panel of the present invention have nonequivalent pitches thereof, the short circuit problem caused by small pitches of the pins in the conventional fabrication process may be avoided. In the preferred embodiment, the pitches of the pins adjacent to the border portion of the driving chip are larger, and therefore the conductive lines electrically connected to the pins in the border portion have larger wiring space. In the present invention, such advantage is suitable for designing the conductive lines with larger widths in the border portion so that the impedances of the conductive lines in the border portion may be efficiently lowered. As a result, compact wiring lines or fine and delicate winding lines for the design of the conductive lines are not needed. Also, the obvious increase of the lengths of the conductive lines may be avoided.

Briefly speaking, the present invention includes the design of providing the driving chips that have pins with equivalent pitches and the adjustable widths of the conductive lines. Also, by virtue of varying the wave amplitudes of the conductive lines in the winding regions, the impedances of the conductive lines may be equalized and the process yield of the conductive lines may be efficiently improved, such that the display quality of the flat display panel may be further improved.

Those skilled in the art will readily observe that numerous modifications and alterations of the device and method may be made while retaining the teachings of the invention.

What is claimed is:

1. A flat display panel, comprising:
a substrate, having a display area and a peripheral circuit area disposed on at least one side of the display area;
at least one driving chip disposed in the peripheral circuit area, the driving chip including a plurality of pins, and pitches of the adjacent pins being incompletely identical;
a plurality of control lines disposed in the display area; and
a plurality of conductive lines disposed in the peripheral circuit area and electrically connected to the control lines and the pins, the conductive lines comprising at least a first conductive line, a second conductive line adjacent to the first conductive line, and a third conductive line adjacent to the first conductive line, a first pitch being between the pin electrically connected to the first conductive line and the pin electrically connected to the second conductive line, and a second pitch being between the pin electrically connected to the first conductive line and the pin electrically connected to the third conductive line, wherein the first pitch is larger than the second pitch, the width of the second conductive line is larger than the width of the first conductive line, and the width of the first conductive line is larger than the width of the third conductive line.

2. The flat display panel of claim 1, wherein the control lines disposed in the display area are parallel to each other.

3. The flat display panel of claim 1, wherein the widths of the conductive lines electrically connected to the pins in the border portion of the driving chip are larger than the widths of the conductive lines electrically connected to the pins in the central portion of the driving chip.

4. The flat display panel of claim 1, wherein the driving chip has a central line, the pitches of the pins adjacent to the central line are smaller than the pitches of the pins away from the central line.

5. The flat display panel of claim 4, wherein the pins on two sides of the central line are symmetrically arranged with respect to the central line serving as a symmetric axis.

6. The flat display panel of claim 5, wherein the conductive lines disposed on two sides of the central line are symmetrically arranged with respect to the central line serving as a symmetric axis.

7. The flat display panel of claim 4, wherein the conductive lines disposed on the left side and the right side of the central line are asymmetrically arranged.

8. The flat display panel of claim 1, wherein each of the conductive lines has a winding region.

9. The flat display panel of claim 8, wherein a portion of each of the conductive lines disposed in the winding region has a plurality of serrated shapes or wavelike shapes, and the serrated shape or the wavelike shape of each of the conductive lines has a wave amplitude.

10. The flat display panel of claim 9, wherein the wave amplitude of each of the conductive lines disposed in the border portion of the driving chip is larger than the wave amplitude of each of the conductive lines disposed in the central portion of the driving chip.

11. The flat display panel of claim 9, wherein the adjacent conductive lines have a minimum distance about 6 micrometers to 8 micrometers in the winding region.

12. The flat display panel of claim 1, wherein the minimum pitch of the adjacent pins is about 20 micrometers, and the maximum pitch of the adjacent pins is about 50 micrometers.

13. The flat display panel of claim 1, wherein each of the conductive lines disposed in the central portion of the driving chip has a winding region, and each of the conductive lines disposed in the border portion of the driving chip has no a winding region.

14. The flat display panel of claim 1, wherein the driving chip comprises a chip-on-film (COF) packaged chip.

15. A flat display panel, comprising:
a substrate having a display area and a peripheral circuit area disposed on at least one side of the display area;
at least one driving chip disposed in the peripheral circuit area, the driving chip including a plurality of pins, and pitches of the adjacent pins being incompletely identical, wherein the pitches of the pins in the central portion of the driving chip are smaller than pitches of the pins in the border portion of the driving chip;
a plurality of control lines disposed in the display area; and
a plurality of conductive lines disposed in the peripheral circuit area and electrically connected to the control lines and the pins, wherein at least parts of the conductive lines have winding regions.

16. The flat display panel of claim 15, wherein the widths of the conductive lines electrically connected to the pins in the border portion of the driving chip are larger than the widths of the conductive lines electrically connected to the pins in the central portion of the driving chip.

17. The flat display panel of claim 15, wherein the widths of the conductive lines are identical.

18. The flat display panel of claim 15, wherein a portion of each of the conductive lines disposed in the winding region has a plurality of serrated shapes or wavelike shapes, and the serrated shape or the wavelike shape of each of the conductive lines has a wave amplitude.

19. The flat display panel of claim 18, wherein the wave amplitudes of the conductive lines disposed in the border portion of the driving chip are larger than the wave amplitudes of the conductive lines disposed in the central portion of the driving chip.

20. The flat display panel of claim 18, wherein the adjacent conductive lines have a minimum distance about 6 micrometers to 8 micrometers in the winding region.

21. The flat display panel of claim 15, wherein the minimum pitch of the adjacent pins is about 20 micrometers, and the maximum pitch of the adjacent pins is about 50 micrometers.

22. The flat display panel of claim 15, wherein each of the conductive lines disposed in the central portion of the driving chip has a winding region, and each of the conductive lines disposed in the border portion of the driving chip has no a winding region.

23. The flat display panel of claim 15, wherein the driving chip comprises a chip-on-film (COF) packaged chip.
